(19) United States
(12) Patent Application Publication
(10) Pub. No.: US 2005/0233083 A1
(43) Pub. Date: Oct. 20, 2005

(54) Method for reducing boundary surface reflection of plastic substrates and substrate modified in such a manner and use thereof

(76) Inventors: Ulrike Schulz, Kunitz (DE); Norbert Kaiser, Jena (DE); Peter Munzert, Jena (DE); Michael Scheler, Jena (DE); Hein Uhlig, Jena (DE)

Correspondence Address: MARSHALL & MELHORN, FOUR SEAGATE, EIGHT FLOOR, TOLEDO, OH, 43604, US

(21) Appl. No.: 10/525,444

(22) PCT Filed: Jul. 14, 2003
(86) PCT No.: PCT/EP03/07583

§ 371 Date: Feb. 24, 2005

(30) Foreign Application Priority Data
Sep. 9, 2002 (DE) 102417083

(51) Int. Cl. B05D 3/04; B05D 3/10

(52) U.S. Cl. 427/342

(57) ABSTRACT

The present invention relates to a process for reducing the surface reflectance of polymer substrates by means of ion bombardment, in which at least one substrate surface is modified by means of an argon/oxygen plasma with formation of a refractive index gradient layer.

The invention relates to a process for reducing the surface reflectance of polymer substrates by means of ion bombardment. The surface of the substrate here is modified with formation of a refractive index gradient layer. The invention also relates to a substrate modified by this process. The process is used for reducing the reflectance of optical elements.

Optical components composed of transparent plastics are assuming constantly increasing importance. The performance of these optical devices can be substantially improved via a reduction in surface reflectances. Methods known hitherto for reducing reflectance of PMMA surfaces include reflectance-reducing layers, e.g. in DE 43 25 011 and U.S. Pat. No. 6,177,131, and antireflection layer systems, e.g. in WO 97/48992 and EP 698 798. These are layer systems composed of at least one other material, the systems being applied to the substrate.

Another alternative consists in applying microstructures, e.g. moth eye structures to the surface. These methods are known from A. Gombert, W. Glaubitt, Thin Solid Films 351 (1999) 73-78 and D. L. Brundrett, E. N. Glytsis, T. K. Gaylord, Applied Optics 16 (1994) 2695-2706.

All of the processes described above are very complicated methods of achieving good reflectance-reducing action, in relation to production of reproducible layer thicknesses, to the adhesion of the vapor-deposited layers on the PMMA surface, and to the precision of the microstructures. In particular, interference layers for reflectance reduction can never be optimized for more than a narrow range of angles of incident light. At relatively large angles of incidence and outside a wavelength range mostly restricted to the region of the visible spectrum, the result is mostly an increase in residual reflectances. There is therefore no satisfactory solution providing reflectance reduction for high-curvature lenses and for optical elements with surface structures.

Against this background, it was an object of the present invention to provide a process which can reduce surface reflectance and which can reduce the reflectance of polymer substrates in a simple and therefore inexpensive manner. At the same time, substrates produced in this way are intended to exhibit high efficiency with respect to transmittance within a very broad region of the spectrum, this property being very substantially independent of surface structures.

This object is achieved via the process with the features of claim 1 and the substrates with the features of claim 10, produced by way of this process. Claim 13 describes the use of the process. The other dependent claims indicate advantageous embodiments.

The invention provides a process for reducing the surface reflectance of polymer substrates by means of ion bombardment. This process modifies at least one substrate surface by means of an argon/oxygen plasma with formation of a gradient layer, and this gradient relates to the refractive index. Application or generation of a refractive index gradient layer is one way of reducing the reflectance of surfaces of polymer substrates. Surprisingly, it has been shown that in the case of certain polymers this type of refractive index gradient can be brought about via a suitable plasma etching procedure, which produces a surface layer whose degree of compaction constantly and gradually reduces toward the surface. The etching properties are very markedly affected by addition of oxygen to the argon plasma from a plasma ion source.

The process preferably reduces the surface reflectance to less than 2%, preferably less than 1.5%, in the wavelength range from 400 nm to 1100 nm and, respectively, less than 1% in the wavelength range from 420 nm to 860 nm.

Decisive parameters in the conduct of the process are the treatment time, and also the energy of the ions impacting the substrate. These two parameters affect the thickness of the gradient layer, and a certain minimum thickness of the gradient layer is needed here in order to give this type of reduction in the reflectance of the surface of the polymer substrate. If the depth of modification is below a certain value, e.g. if the ion energy is too low or the treatment time is too short, the reflectance increases markedly in the long-wavelength region of the spectrum. In contrast, even small thicknesses of the gradient layer here can achieve reflectance-reducing action in the short-wavelength region.

The modification takes place via bombardment of the substrate surface with high-energy ions, which are generated by means of a plasma ion source.

Any of the known standard prior-art processes of coating technology may be used for the plasma treatment here, as long as they have appropriate properties in relation to the nature of the plasma and also to the energies of the ions.

The plasma treatment is preferably carried out using an oxygen-containing DC argon plasma. The energy of the ions impacting the substrate during the ion bombardment is preferably from 100 eV to 150 eV, particularly preferably from 120 eV to 140 eV. The treatment time here is preferably from 200 to 400 s, particularly preferably from 250 to 350 s.

The plasma used is preferably operated with at least 30 sccm of oxygen. The ion bombardment here is carried out in vacuo, a preferred pressure here being about 3×10⁻⁴ mbar.

The polymer substrates used preferably comprise polymethyl methacrylate (PMMA) or methyl-methacrylate-containing polymers, among which are not only copolymers but also blends. The polymer substrate used may also comprise diethylene glycol bisallyl carbonate (CR39).

If the polymer used comprises polymethyl methacrylate (PMMA), the energy selected for the ions impacting the substrate during the ion bombardment is from 100 eV to 160 eV, preferably from 120 to 140 eV, and the duration of the ion bombardment is from 200 to 400 s, preferably from 250 to 350 s.

If the polymer used comprises diethylene glycol bisallyl carbonate (CR39), the energy selected for the ions impacting the substrate during the ion bombardment is at least 120 eV, preferably 150 eV, and the duration of the ion bombardment here is at least 500 s.

When compared with the prior art, the process has the advantage that the entire duration of the process is substantially shorter than for coating. At the same time, when comparison is made with vapor-deposited antireflection layer systems, the reflectance-reducing action is effective over a considerably wider range and is more stable with respect to reproducibility. In the field of microstructuring of plastics via embossing processes, the plasma treatment can also reduce the reflectance of curved surfaces or Fresnel structures without difficulty and without additional cost.

The invention likewise provides the substrates produced by the process. The surface reflectance on the surface of these has preferably been reduced, in the wavelength range from 400 to 1100 nm, to <2%, preferably to <1.5%.

The thickness of these gradient layers has to be at least 230 nm for reliable provision of the surface-reflectance reduction described above.

The process is used for reflectance reduction on surfaces of any desired mass-produced components composed of polymeric starting materials, because, when compared with the conventional reflectance-reducing processes, the process is very rapid, simple, and inexpensive. Examples which may be mentioned of application sectors are reflection minimization on the inner side of a mobile telephone display cover, and reflectance reduction for Fresnel lenses, or for other optical elements which have complicated geometries and are therefore difficult to coat or to structure, and whose installed situation prevents their exposure to mechanical effects.

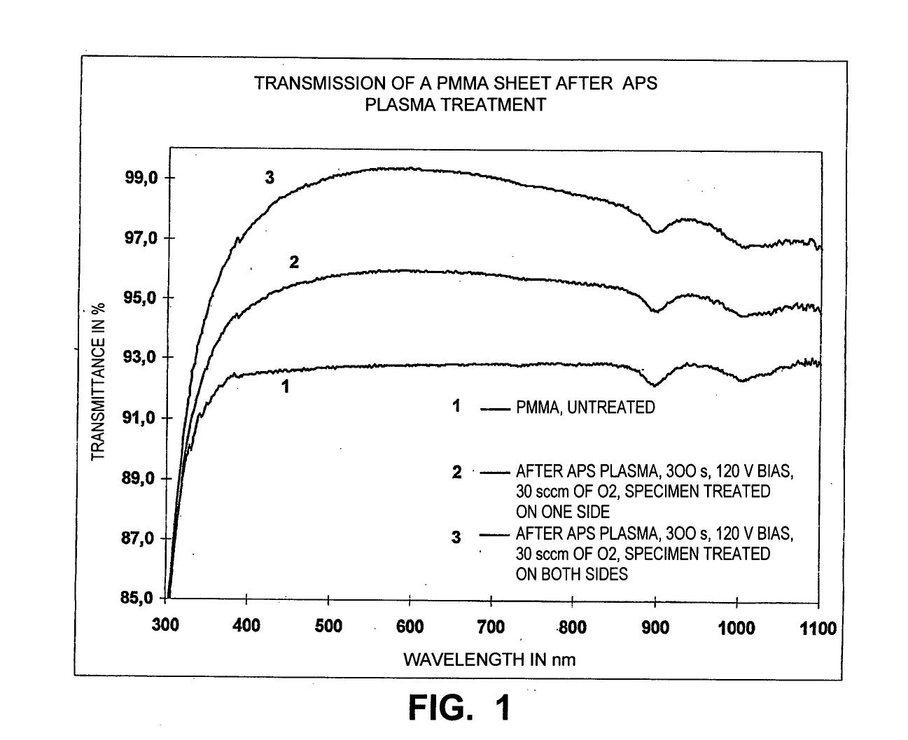

FIG. 1 shows a transmittance spectrum of a PMMA sheet prior to and after the plasma treatment.

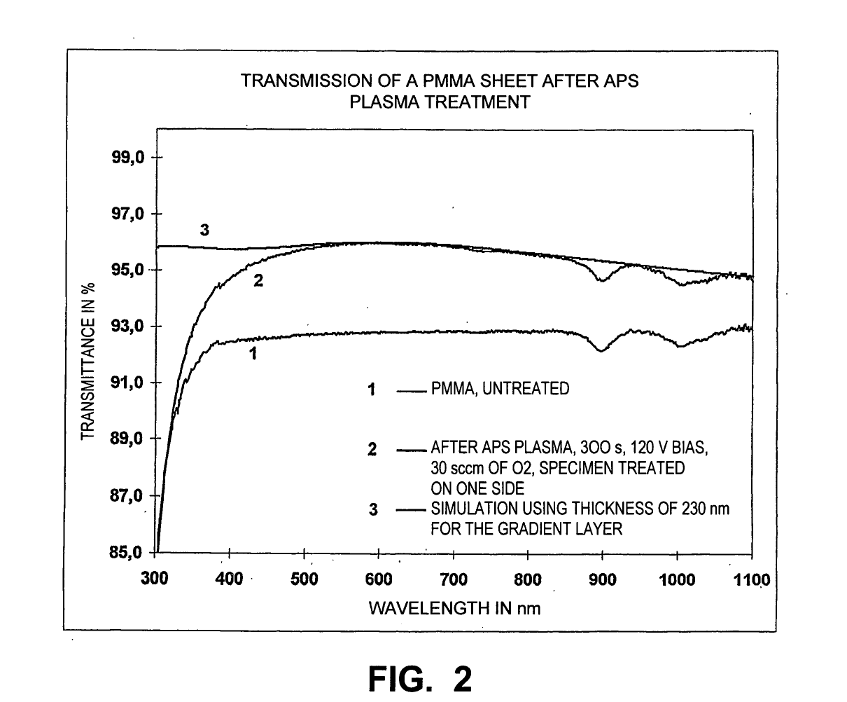

FIG. 2 shows a simulation of a transmittance spectrum of a gradient layer with a thickness of 230 nm.

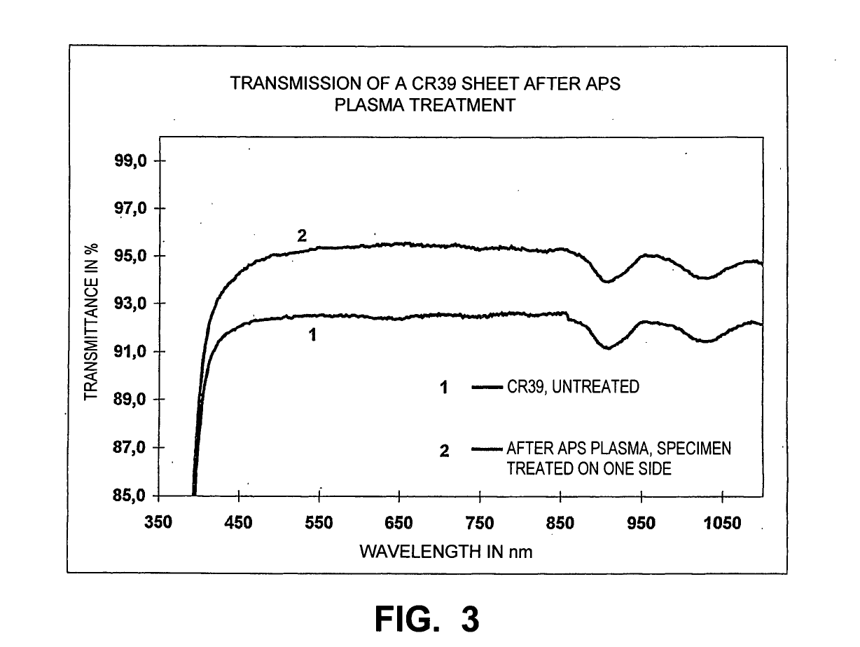

FIG. 3 shows a transmittance spectrum of a CR39 sheet after the plasma treatment.

FIG. 1 illustrates the spectral transmittance of a PMMA sheet prior to and after APS plasma treatment, using the plasma ion source of the APS 904 (Leybold Optics) vacuum-deposition system. The process parameters set included 30 sccm of oxygen, the BIAS potential applied being 120 V and the treatment time being 300 s. The specimen, reflectance-reduced on both sides, achieves a transmittance of at least 97% over a wavelength range from 400 nm to 1100 nm, at least 98% from 420 nm to 860 nm, and at least 99% from 490 nm to 700 nm. The reproducibility of the reflectance reduction is very good when comparison is made with vapor-deposited antireflection layer systems.

FIG. 2 illustrates the transmittance spectrum of an untreated PMMA sheet (1), and also of a PMMA sheet (2) surface-treated on one side. At the same time, this figure illustrates a transmittance spectrum determined by means of a simulation calculation for a gradient layer with a thickness of 230 nm (3). From this it is clear that the thickness of the gradient layer should be at least 230 nm if a high level of surface-reflectance reduction is to be achieved.

FIG. 3 illustrates the transmittance spectrum of a CR39 sheet prior to and after APF plasma treatment using the APS 904 (Leybold Optics) plasma ion source. The average increase in transmittance of a specimen reflectance-reduced on one side is about 2.8% in the wavelength range from 450 nm-800 nm, when comparison is made with the untreated sheet.

### EXAMPLE 1

Polymethyl methacrylate (PMMA) has better suitability than any of the other known plastics for precision-optics applications, because it has excellent optical properties and advantageous performance during shaping in the injection molding process. The performance of the optical devices can be substantially improved via reflectance-reduction on the surfaces, for example transmittance for visible light can be raised as far as 99%. The plasma treatment providing reflectance-reduction on the PMMA surface is carried out by means of the plasma ion source of the APS 904 (Leybold Optics) vacuum-deposition system.

Injection-molded specimens composed of PMMA are installed in the system immediately after production. A pump is used to reduce pressure to 7-8*10⁻⁶ mbar. In order to obtain a reflectance-reducing effect, at least 30 sccm of oxygen has to be admitted into the DC argon plasma from the APS source, and the resultant pressure during the plasma treatment is about 3*10⁻⁴ mbar. At lower oxygen contents, the quality of reflectance-reduction falls away sharply. In order to achieve reproducibly good reflectance-reducing action, the energy of the ions impacting the substrates should be at least 120 eV. The system permits this via the setting of a bias potential of at least 120 V. Increasing the bias potential to 150 V does not give any further reduction in reflectance. If the treatment time is markedly less than 300 s, the reflectance-reducing effect becomes impaired, but increasing the treatment time above 300 s does not give any further improvement in reflectance reduction. Treatment times above 400 s at 120 V BIAS produce marked scattering losses in the short-wavelength region of the spectrum.

### EXAMPLE 2

Polydiethylene glycol bisallyl carbonate (CR39) is a crosslinked thermoset plastic used mainly for spectacle lenses. The plasma treatment leading to reflectance reduction is carried out by means of the plasma ion source of the APS 904 (Leybold Optics) vacuum-deposition system. The specimens are installed in the coating system at a distance of about 70 cm from the ion source, and then the pump is used to reduce pressure to the region of 10⁻⁵ mbar. Operation of the APS source for at least 500 s with pure argon and a bias potential of 150 V (maximum energy of the Ar ions: 150 eV) is sufficient to achieve a reflectance-reducing effect. The reflectance-reducing effect improves if the treatment time is prolonged to a maximum of 1000 s. If a mixture of 1:1 to 2:1 oxygen/argon is used, the reflectance-reducing effect is achieved after a substantially shorter treatment time. The energy of the ions impacting the substrates has to be at least 120 eV in order to achieve reproducibly good reflectance-reducing action. Very good reflectance-reducing action is obtained at a treatment time of 500 s with a 2:1 oxygen/argon mixture, with a system pressure of 3*10⁻⁴ mbar and an ion energy of 150 eV. The average increase in transmittance of a specimen reflectance-reduced on one side is then 2.8% in the wavelength range from 450 nm to 800 nm.

1-15. (canceled)

16. A process for reducing the surface reflectance of polymer substrates to less than 2% in the wavelength range from 400 nm to 1100 nm with formation of a refractive index gradient layer by means of ion bombardment using high-energy ions which are generated by means of an argon/oxygen plasma as plasma ion source, where the ions impacting at least one substrate surface during the ion bombardment have an energy of from 100 eV to 160 eV, and the duration of the ion bombardment is from 200 to 600 s, and the ion bombardment is carried out until a refractive index gradient layer with a thickness of at least 230 nm has been formed.

17. The process as claimed in claim 16, wherein the process reduces the surface reflectance to less than 1.5% in the wavelength range from 420 nm to 860 nm.

18. The process as claimed in claim 16, wherein the ions impacting the substrate during the ion bombardment have an energy of from 120 to 140 eV.

19. The process as claimed in claim 16, wherein the duration of the ion bombardment is from 250 to 350 s.

20. The process as claimed in claim 16, wherein the plasma ion source is operated with at least 30 sccm of oxygen.

21. The process as claimed in claim 16, wherein the ion bombardment is carried out at a pressure of about 3*10⁻⁴ mbar.

22. The process as claimed in claim 16, wherein the polymer substrates are selected from the group consisting of: polymethyl methacrylates (PMMA), methyl-methacrylate-containing polymers, and diethylene glycol bisallyl carbonate (CR39).

23. The process as claimed in claim 22, wherein the polymer substrate comprises polymethyl methacrylate (PMMA), the ions impacting the substrate during the ion bombardment have an energy of from 100 eV to 160 eV, and the duration of the ion bombardment is from 200 to 400 s.

24. The process as claimed in claim 23, wherein the ions impacting the substrate during the ion bombardment have an energy from 120 to 140 eV, and the duration of the ion bombardment is for 250 to 350 s.

25. The process as claimed in claim 22, wherein the polymer substrate comprises diethylene glycol bisallyl carbonate, the ions impacting the substrate during the ion bombardment have an energy of at least 120 eV, and the duration of the ion bombardment is at least 500 s.

26. The process as claimed in claim 25, wherein the ions impacting the substrate during the ion bombardment have an energy of at least 150 eV.

27. A surface-modified substrate comprising a polymer treated by the process as claimed in claim 16.

28. The surface-modified substrate according to claim 27, wherein the polymer is selected from the group consisting of polymethyl methacrylate (PMMA), methyl-methacrylate-containing polymers, or diethylene glycol bisallyl carbonate (CR39).

29. The surface-modified substrate as claimed in claim 27, wherein the at least one substrate surface has a surface reflectance reduced to less than 2% in the wavelength range from 400 to 1100 nm.

30. The surface-modified substrate as claimed in claim 27, wherein the thickness of the gradient layer is at least 230 nm.

31. The surface-modified substrate as claimed in claim 28, comprising a polymethyl methacrylate substrate which is modified on one side and has a transmittance of at least 95%.

32. The surface-modified substrate as claimed in claim 28, comprising a polymethyl methacrylate substrate which is modified on both sides and has a transmittance of at least 97% in the wavelength range from 400 nm to 1100 nm.

33. Utilizing the method of claim 16 for reducing the reflection of optical elements.
